(19) United States
(12) Patent Application Publication
(10) Pub. No.: US 2019/0002314 A1
(43) Pub. Date: Jan. 3, 2019

(54) SYSTEMS AND METHODS FOR PREVENTING AND REMOVING SCALE IN SANITIZING SYSTEMS

(71) Applicant: Arch Chemicals, Inc., Allendale, NJ (US)

(72) Inventor: Christopher Bouch, Alpharetta, GA (US)

(21) Appl. No.: 16/015,401

(22) Filed: Jun. 22, 2018

Related U.S. Application Data
(60) Provisional application No. 62/527,238, filed on Jun. 30, 2017.

(51) Int. Cl. C02F 1/66; C02F 1/00

(52) U.S. Cl. CPC C02F 1/66; C02F 1/008; C02F 2103/42; C02F 2303/22; C02F 2209/06

(57) ABSTRACT

Methods and systems for preventing scale formation in water sanitizing systems are provided, particularly for pools, industrial water, and potable water treatment. A scale prevention system includes a water line having a pH sensor and an acid injection port. A scale prevention system controller monitors the pH of the water line and acidifies the water to reduce, eliminate, and remove scale from the sanitizing system. The scale prevention controller has both functionality and safety interlocks, and can administer acid to the water line continuously or in bursts.

### RELATED APPLICATIONS

The present application is based on and claims priority to U.S. Provisional Application Ser. No. 62/527,238, having a filing date of Jun. 30, 2017, which is incorporated herein by reference in its entirety.

### BACKGROUND

Sanitizing assemblies for use in swimming pools, potable water systems, industrial water, and other water treatment systems typically use chlorination to disinfect and eliminate microorganisms. The chlorine source for sanitizing assemblies is typically in concentrated solid form, including calcium hypochlorite. However, to accurately administer the calcium hypochlorite and adjust chlorine concentration, the calcium hypochlorite must first be put into solution.

Sanitizing assemblies therefore rely on chlorinators to dissolve the chlorine solids and hold the chlorinated solution prior to its ultimate use. A grid is generally provided to support the chlorine solids and water is fed into the chlorinator, which abrades and dissolves the chlorine solids. A recycle loop may also be present that helps further dissolve the chlorine solids and keeps particulates in solution. Although the sanitizing assemblies are generally automatic, scale formation often occurs in the chlorinator and its associated equipment. This scale formation can foul sensors, plug spray nozzles, cause process disruptions, and even cause equipment failures. As a result, the art is in need of ways to prevent and remove scale formation in sanitizing systems.

### SUMMARY

This invention includes systems and methods for preventing and removing scale in sanitizing systems. Systems and methods in accordance with the invention can be particularly advantageous for preventing and removing scale in chlorine-based sanitizing systems.

According to a first aspect, a method for preventing scale formation in a sanitizing system is provided. The method includes circulating pre-chlorinated water to a chlorinator, the pre-chlorinated water having a pH; monitoring the pH of the pre-chlorinated water upstream from the chlorinator; and lowering the pH of the pre-chlorinated water entering the chlorinator based on the monitored pH of the pre-chlorinated water. The pH of the pre-chlorinated water is lowered an amount sufficient to inhibit scale formation in the chlorinator.

The method can further include mixing the lowered pH pre-chlorinated water prior to it entering the chlorinator and monitoring the pH of the pre-chlorinated water after it has been acidified. The pre-chlorinated water can be continuously acidified or acid can be introduced to the pre-chlorinated water intermittently. Conditions including pH, flowrate, and pressure are monitored to optimize system performance, avoid system upsets, and prevent equipment wear and failure.

According to a second aspect, a system for preventing scale formation in a sanitizing system includes a pre-chlorinated water line and a pH sensor attached to the pre-chlorinated water line. An acid storage container is connected to an acid feeder, and the acid feeder is connected to the pre-chlorinated water line via an acid injection port. A scale prevention system controller monitors the pH sensor and regulates the addition of acid through the acid feeder. The system is designed to lower the pH with an amount of acid sufficient to inhibit scale formation.

The acid feeder can be a positive displacement pump, such as a peristaltic pump. The system has a mixer in the pre-chlorinated water line downstream from the acid injection port. A fail-closed control valve is located between the acid storage container and the acid feeder, and its position is regulated by the scale prevention system controller. Alternatively, or in addition, a check-valve can be included on the flow line between the acid storage container and the acid feeder. The system can be integrally formed with a chlorinator connected to the pre-chlorinated water line.

Other features and aspects of the present disclosure are discussed in greater detail below.

### BRIEF DESCRIPTION OF THE DRAWINGS

A full and enabling disclosure of the present invention is set forth more particularly in the remainder of the specification, including reference to the accompanying figures, in which:

FIG. 1 shows a schematic view of an automatically controlled water sanitizing system in accordance with this invention.

FIG. 2 shows a schematic view of an automatically controlled chlorinator assembly in accordance with this invention.

FIG. 3 shows a schematic view of a scale prevention system in accordance with this invention.

FIG. 4 shows an image of an experimental prototype of a chlorinator scale prevention system in accordance with this invention.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

This invention relates to automatically controlled systems and methods for preventing scale formation in sanitizing systems. Examples of scale that cause problems in sanitizing systems include calcium hydroxide, carbonate, bicarbonate, and other insoluble compounds and compositions. The present invention is particularly applicable to pool and potable water sanitizing systems or other systems where water needs to be chlorinated.

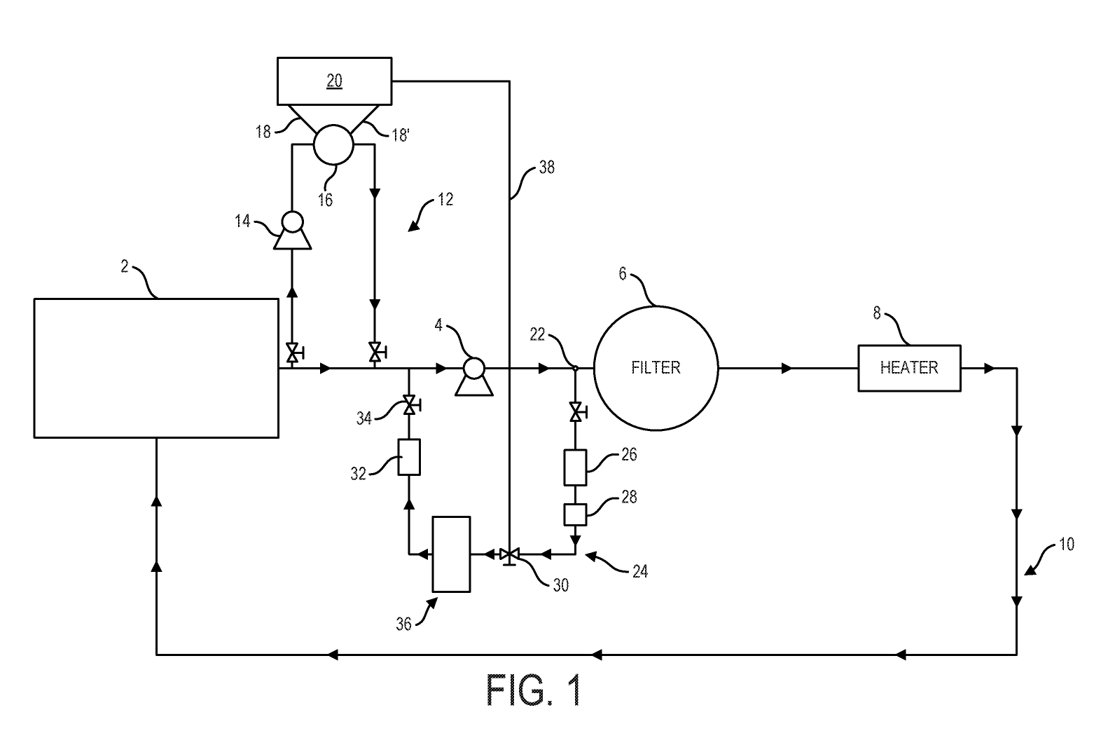

FIG. 1 shows a schematic of an automatically controlled pool sanitizing system in accordance with the present invention. A water treatment loop 10 is provided to keep the reservoir 2 free from unwanted microorganisms. Optionally, a heater 8 can also be included in the water treatment loop 10 to adjust the temperature of the treated water.

The flow of water in the water treatment loop 10 is driven by the recirculation pump 4. The recirculation pump 4 has an input that draws water from the reservoir and provides pressure to drive the flow of water through the optional filter 6 and optional heater 8. A chlorination loop 24 is provided to adjust the concentration of chlorine in the treated water. The water treatment loop 10 then returns the chlorinated, filtered, and potentially heated water back to the reservoir 2.

To automatically adjust the pH, available chlorine levels, and other water properties, a side sensing loop 12 is provided. The side sensing loop 12 is in parallel with the inlet portion of the water treatment loop 10 and draws untreated water, prior to being chlorinated, filtered or heated. To be clear, the terms “water prior to being chlorinated” and “pre-chlorinated water” refer to water that has yet to pass through the chlorinating section of the water treatment loop, yet may still have chlorine in concentrations corresponding with that of the reservoir. The side sensing loop 12 is driven by a booster pump 14 that supplies the pressure to drive the untreated water through a sensing chamber 16. The sensing chamber 16 includes a pH sensor 18 and an oxidation sensor 18′. The pH measurements from the pH sensor 18 are recorded by a microprocessor controller 20 so that a pool attendant can monitor and adjust the pool water pH accordingly. In addition, the pH sensor 18 can be used to support an automatic pH control loop (not shown).

The oxidation reduction sensor 18′ measures the disinfectant activity or potential of the reservoir water. The disinfectant potential of the reservoir water is not a direct measurement of the amount of chlorine in the reservoir, but can depend on other factors such as pH, temperature, bather load, and other solutes present in the reservoir water. Without being limited by theory, the general mechanism of action for sanitizing the reservoir water is to oxidize the contaminants using chlorine. Regardless of the particular chlorine source being added to the reservoir, the main oxidizing agent is hypochlorous acid, the concentration of which is determined by the amount of chlorine in the reservoir in combination with the other listed factors. Therefore, the oxidation reduction sensor 18′ determines the “available chlorine” as an indicator of the reservoir water's disinfectant potential. Of particular importance to the present invention, the microprocessor controller 20 (in combination with the pH sensor 18 and oxidation reduction sensor 18′) determines when chlorine is to be added to the reservoir 2.

The microprocessor controller 20 adds chlorine to the pool by activating the chlorinating loop 24 via a solenoid valve 30 through a solenoid valve control line 38. In the embodiment shown in FIG. 1, the chlorinating loop 24 is shown in parallel with the recirculating pump 4. Having the input of the chlorinating loop 24 connected to the output line of the recirculating pump 4 is convenient because it avoids the requirement of an additional pressure source for driving the chlorinating loop 24. It also ensures that added chlorine is thoroughly mixed prior to the chlorinated water entering the filter 6 or heater 8, avoiding high chlorine concentrations which may damage this equipment.

The chlorinating loop 24 includes a chlorinating loop entry 22 that draws pressurized water coming from the recirculating pump 4. The water passes through the chlorinating loop 24 by first entering a strainer 26. Its flowrate is measured by a flow indicator 28, and then the water passes through the solenoid valve 30 that controls the chlorinating loop 24 flowrate. The water then continues through the chlorinating loop 24 by passing through the chlorinator assembly 36, a check valve 32, and an exit ball valve 34. Backflow in the chlorinating loop 24 may be especially problematic for the chlorinator assembly 34. The check valve 32 ensures that backflow does not occur in the chlorinating loop 24 during, for example, startup and shutdown of the recirculating pump 4. The inlet ball valve (shown but not labeled) and the outlet ball valve 34 can be used to isolate the chlorinating loop 24 from the water treatment loop 10 such that the chlorinating loop can be replaced or maintained.

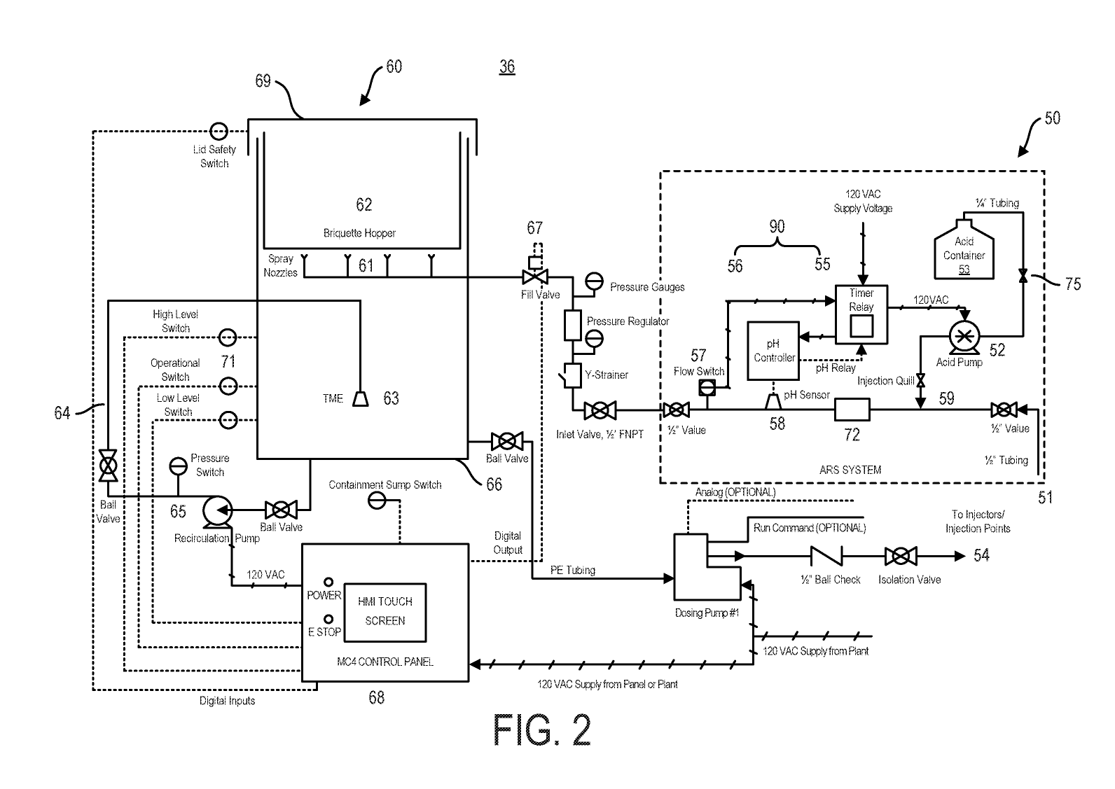

FIG. 2 shows a chlorinator assembly 36 in accordance with the present invention. The chlorinator assembly 36 includes two major components, a chlorinator 60 and a scale prevention system 50. It should be noted that FIG. 2 shows one example of a chlorinator, but other chlorinators are known to exist in the prior art and the systems and methods of the present invention can be equally applied to other chlorinator configurations. The purpose of the scale prevention system 50 is to reduce or eliminate scale formation in the chlorinator assembly 36, as well as the chlorinating loop 24 as a whole. The scale prevention system 50 can also serve to remove existing scale. The chlorinator assembly 36 interfaces with the water treatment loop 10 via an inlet 51 that draws water from the water treatment loop 10 and an outlet 54 that returns water to the water treatment loop 10. The water flows through the chlorinator assembly 36 by passing through the scale prevention system 50 and then the chlorinator 60.

The chlorinator 60 of FIG. 2 includes a fill valve 67 that controls the flow of water into the chlorinator container 66, which has a lid 69. Water coming into the chlorinator 60 passes through a set of spray nozzles 61 and is sprayed into a briquette or pellet hopper 62. The hopper 62 generally contains a grid (not shown) that supports the briquettes or pellets of chlorinating substance present in the hopper 62. Calcium hypochlorite is commonly used as the chlorinating material.

The water exits the spray nozzles 61 and serves to abrade and dissolve the chlorinating substance, forming a chlorinated solution that is stored in the base of the container 66. The chlorinator 60 further includes a chlorinator controller 68 that monitors the level (or volume) and concentration of chlorinated solution in the container 66. The chlorinator controller 68 also regulates a recirculation pump 65, which draws the chlorinated solution from the container 68, pumps it through a recirculation line 64, and ejects the chlorinated water through a mixing discharge nozzle 63. This configuration serves to keep solids suspended in the chlorinated solution, as well as providing another means for dissolving and abrading the chlorinating briquettes.

Although chlorinator loops 34 of the prior art are designed to be automatic, they often require user maintenance and part replacement due to scale buildup. Specifically, scale can form within the ball valves 34, strainer 26, flow indictor 28, and solenoid valve 30 of the chlorinating loop 24. Perhaps most detrimental, scale can form within the chlorinating assembly 36. In particular, scale can form in the briquette hopper 62 (including on the support grid within the briquette hopper), the recirculation line 64, the recirculation pump 65, and the fill valve 67. Scale can also form on the level sensors 71, the spray nozzles 61, and the mixing discharge nozzle 63.

Scale formation can reduce the effectiveness of the chlorinating loop 24, or even render it inoperable. For example, scale can foul the spray nozzles 61 and mixing discharge nozzle 63, reducing the ability of the chlorinator 60 to put chlorine into solution and potentially resulting in a buildup of solids in the bottom of the chlorinator container 66. Scale on the level sensors 71 can result in chlorinator malfunction as the chlorinator controller 68 is unable to obtain accurate level measurements. In addition, the recirculation pump 65 and recirculation line 64 can foul with scale, reducing efficiency, requiring maintenance, and causing parts to fail prematurely.

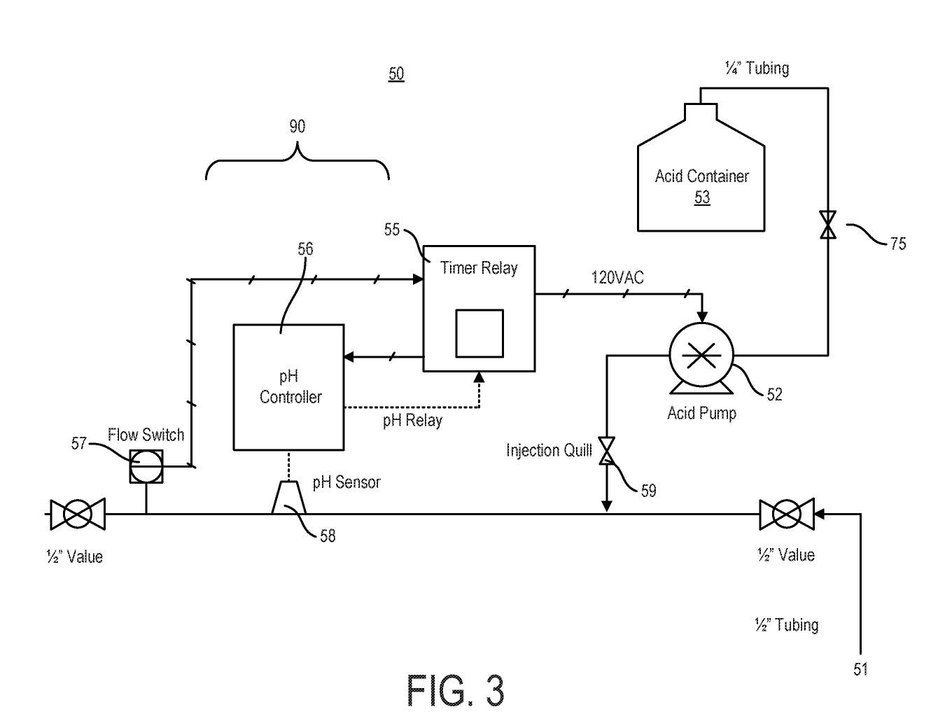

A chlorinating loop 24 in accordance with the present invention includes a scale prevention system 50. The scale prevention system 50 can be integrally formed as part of the chlorinator assembly 36. Alternatively, the scale prevention system 50 can exist elsewhere within the chlorinating loop 24 (e.g., before the solenoid valve 30, before the flow indicator 28, or before the strainer 26). FIG. 2 shows the scale prevention system 50 enclosed within a dashed line, with this portion expanded in FIG. 3.

The scale prevention system 50 of FIGS. 2 and 3 includes a pH sensor 58 and an acid injection port (or quill) 59 that is connected to the chlorinating loop 24 prior to chlorinator 60. The acid injection port 59 is connected to an acid feeder 52, which draws acid from an acid storage container 53. Suitable acids for this application are known in the art and include hydrochloric acid or muriatic acid. The acid feeder 52 can be a positive displacement pump such as a peristaltic pump, reciprocating pump (e.g. a piston pump diaphragm pump, or plunger pump), or rotary lobe pump. Alternatively, the acid feeder 52 can be implemented without the use of a pump. For example, the acid can be gravity-, vacuum-, or siphon-fed into chlorinating loop 24 using the flow of water in the chlorinating loop 24. An acid flow measurement sensor and control valve (not shown) can be used to adjust the flowrate and duration of acid being delivered to the chlorinating loop 24. Furthermore, a check valve (not shown) can be included on the acid flow line to prevent chlorinating loop water from backflowing into and potentially overflowing the acid storage container 53.

The pH sensor 58 can be located anywhere on the chlorination loop 24, but is preferably located downstream from the acid injection port 59. This configuration is preferable because it enables the pH sensor 58 to measure the pH of the chlorinating loop 24 after acid is introduced via the acid injection port 59. In an alternative embodiment, one or more additional pH sensors (not shown) can be included upstream of the acid injection port. A mixer 72, preferably a static mixer, can be included after the acid injection port 59 to thoroughly incorporate the acid into the water prior to it flowing through any subsequent process equipment. The mixer 72 is preferably located before the pH sensor 58 such that the pH sensor is able to obtain an accurate measurement of the pH in the chlorinating loop post acid injection.

The scale prevention system 50 can operate autonomously and has a broad range of functionality. The automation of the scale prevention system 50 is overseen by the scale prevention system controller 90. In FIGS. 2 and 3, the scale prevention system controller is illustrated by a pH controller 56 and a timer relay 55. For embodiments in which the scale prevention system 50 is integrally formed as part of the chlorinator assembly 36, the chlorinator controller 68 and the scale prevention system controller 90 can be combined in the form of a single chlorinator assembly controller.

The scale prevention system controller 90 monitors and records chlorinating loop flowrate (via a flowmeter), acid injection, chlorinating loop pH prior to acidification, and chlorinating loop pH post acidification. Furthermore, the scale prevention system controller 90 determines when and how much acid to introduce to the chlorinating loop 24. As a safety feature, the scale prevention system controller 90 can regulate a stop valve 73 to cease the introduction of acid in the system. This feature may be particularly useful if the acid container empties or there is another type of system upset, such as the chlorinating loop pH dropping too low. Chlorinating loop pH detection can be monitored through the shown pH sensor 58; however, for redundancy and additional system monitoring, pH sensors can also be included on one or more of the recirculation line 64, the chlorinator 60, and the chlorinator discharge line (not shown).

The scale prevention system controller 90 can control conditions (or interlocks) for starting and stopping the addition of acid into the chlorinating loop 24. For example, prior to engaging the scale prevention system 50, the controller can ensure that the flowrate in the chlorinating loop 24 is above a threshold (e.g., 7.5 gpm), the pH of the chlorinating loop water is above a threshold (e.g. 6.0), and the pressure in the chlorinating loop is below a threshold (e.g., 80 psi). The controller 90 can also cease operation of the scale prevention system 50 when the pH falls below a threshold (e.g., 3.8), the flowrate falls below a threshold (e.g., 5.0 gpm), or the pressure rises above a threshold (e.g., 80 psi). For systems that operate at higher pressures, a pressure reducing valve (not shown) can be installed on the chlorinating loop 24 prior to the scale prevention system 50. The controller 90 may also stop the addition of acid after a certain period of operation (e.g., five minutes).

As stated above, the scale prevention system 50 has a broad range of functionality. For example, the scale prevention system controller 90 can administer a constant trickle of acid whenever the chlorinating loop 24 is in operation. Optimum pH levels are generally in the range of from 7.0 to 7.4. Therefore, the pH of the water in the chlorinating loop 24 can be maintained slightly below that of the pH of the pool (e.g., a pH of from 5.0 to 7.0, or from 5.5 to 6.5, or about 6.0 or 6.5). As the fraction of water that enters the chlorination loop 24 is small relative to the reservoir volume and the flowrate of the recirculating pump 4, this should not materially affect the pool pH or the remainder of the water treatment loop 10.

In another mode, the scale prevention system controller 90 can introduce acid intermittently or in bursts. For example, the controller 90 can add acid to the chlorinating loop to maintain a specified pH for an amount of time or for a specified volume of water to be passed through the chlorination loop 24. In a burst, the pH of the chlorination loop can be lowered to a range from 3.5 to 7.0, or from 4.0 to 6.5, or from 4.5 to 6.0. Alternatively, a burst can maintain a pH set point of about 4.5, 5.0, 5.5, 6.0, or 6.5.

The burst can be time dependent or volume dependent. For example, a burst can last from a few seconds, to a few minutes, to a few hours. Specific examples include a burst lasting from 10 seconds to five minutes, or from 1 to 3 minutes, or about 3 minutes. For volume dependent bursts, the scale prevention system controller 90 can maintain the pH in the chlorination loop within a range or at a set point for a specified volume that passes through the chlorination loop. That is, the pH can be maintained at any of the listed ranges or set points continuously for the passage of a given amount of water through the chlorination loop. In one example, the controller can maintain the pH in the chlorinating loop 24 at about 6.0 for approximately 20 gallons of flow (e.g., for a period of 2 minutes with a 10 gpm flowrate in the chlorinating loop 24).

In a yet another mode, the scale prevention system controller 90 can combine the constant trickle mode with the burst mode. Without be limited by theory, the constant trickle can prevent or inhibit the formation of scale by continuously introducing small amounts of acid into the system, while an occasional burst of acid can be used to shock the system and remove and dissolve particularly stubborn scale and particulate matter. However, it should be noted that the scale prevention system 50 will typically only be in operation while the chlorinating loop 24 is engaged. In FIG. 1, engaging the chlorinating loop is demonstrated by the microprocessor controller 20 opening the solenoid valve 30.

In addition to controlling the duration of acid addition based on volume or time, the frequency of bursts can also be dependent on time or volume of flow. For example, the scale prevention system controller 90 can initiate a burst every four hours, every day, or once per week. Alternatively, the scale prevention system controller 90 can initiate a burst after every 10, 100, or 1000 gallons of flow through the chlorinating loop 24. The controller 90 can also be programmed to adjust the frequency and duration of bursts based on the continuously recorded pH of the flow. That is, water that is maintained at a lower pH may require more frequent bursts or bursts of longer duration.

It has been stated that the scale prevention system controller 90 maintains the pH in the chlorinating loop at specific levels or ranges. The ability to adjust pH using muriatic acid is well known in the art and the scale prevention system controller 90 can be preprogrammed with this baseline information. However, as a broad example, between 0.0 and 4.0 mL of muriatic acid can be added per gallon of water that passes through the chlorinating loop. This can result in water to acid ratios ranging from 4000 to 500, 4000 to 1500, and 3000 to 1000.

Although calculating the amount of acid required to adjust the pH of water is well known in the art, the scale prevention system controller 90 can establish a feedback loop with the one or more pH sensors. This functionality can take into account whatever pH buffering may be occurring within the water source or chlorinating system. For example, the scale prevention system controller 90 may set a baseline acidification rate of 1.0 mL of acid per gallon of water with a target pH of 6.0. However, if the downstream pH sensor measures the pH to be 6.5, the controller 90 can increase the acid to water ratio until the target pH is achieved. Alternatively, if the target pH is 6.5 and the sensed pH is 5.5, the controller 90 can reduce the acidification rate.

The discussed feedback loops can be established with any of the pH sensors on the chlorinating loop 24, including the pH sensor 58 before the chlorinator, as well as pH sensors on the chlorinator or chlorinator outlet (not shown). However, for automation purposes, it should be noted that there may be significant lag between the beginning of acidification and pH stabilization within the chlorinator. Therefore, the feedback loop should not be overly aggressive such that it overshoots the target pH.

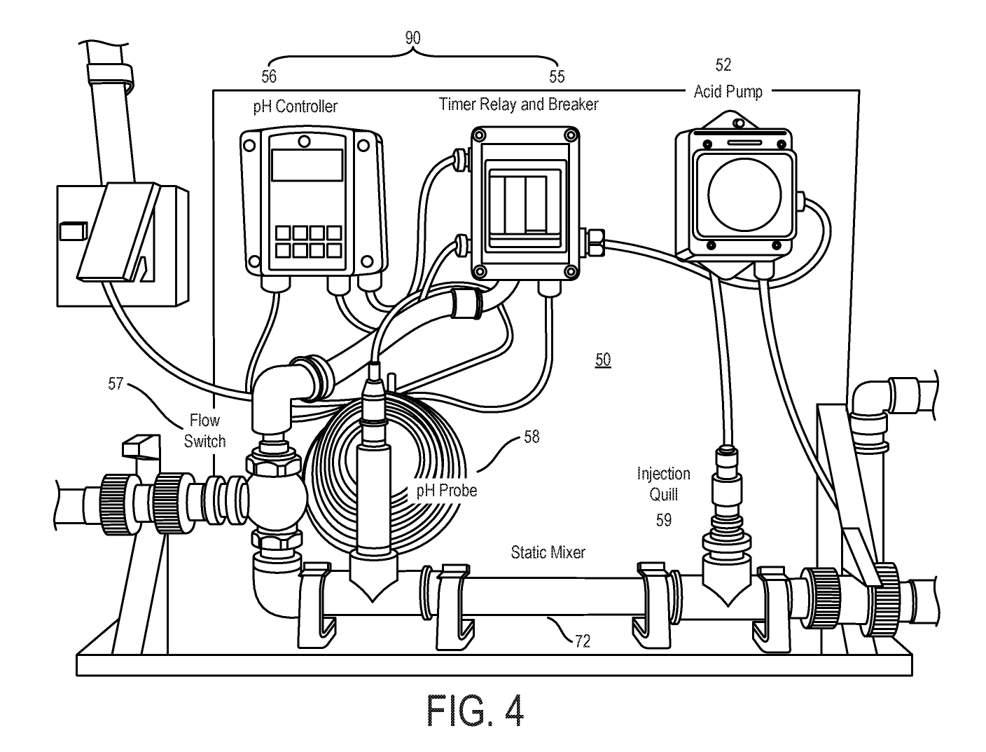

FIG. 4 shows an image of an experimental prototype of a scale prevention system in accordance with this invention. The system includes a scale prevention system controller 90 comprised of a pH controller 56 and a timer and relay breaker 55. The controller 90 regulates the acid feeder 52, which is a peristaltic pump. Peristaltic pumps are particularly advantageous for this application because they can run continuously and administer accurate flowrates of acid. Furthermore, peristaltic pumps can handle corrosive substances, are easy and inexpensive to maintain, and are resistant to siphoning and backflow. The experimental embodiment includes a static mixer 72 downstream from the acid injection port 59, yet upstream from the pH probe 58. As previously discussed, this configuration is preferred because it allows for a single pH sensor to be able to first measure the pre-chlorinated water pH prior to acidification, and then monitor the pH of the acidified pre-chlorinated water after acidification.

It should be understood that the embodiments, examples, and the experimental prototype described herein are for illustrative purposes only and aspects of the various embodiments may be interchanged both in whole or in part. Furthermore, those of ordinary skill in the art will appreciate that the foregoing description is by way of example only, and is not intended to limit the invention as described in the appended claims.

What is claimed:

1. A method for preventing scale formation in a sanitizing system comprising:
circulating pre-chlorinated water from a body of water to a chlorinator, the pre-chlorinated water having a pH;
monitoring the pH of the pre-chlorinated water upstream from the chlorinator; and
lowering the pH of the pre-chlorinated water entering the chlorinator based on the monitored pH of the pre-chlorinated water, the pH of the pre-chlorinated water being lowered an amount sufficient to inhibit scale formation in the chlorinator.

2. The method of claim 1, further comprising mixing the lowered pH pre-chlorinated water prior to it entering the chlorinator.

3. The method of claim 1, further comprising monitoring the pH of the pre-chlorinated water after it has been lowered.

4. The method of claim 1, further comprising continuously lowering the pH of the pre-chlorinated water.

5. The method of claim 1, further comprising intermittently lowering the pH of the chlorinated water.

6. The method of claim 1, further comprising determining whether one or more conditions are met prior to the lowering the pH of the pre-chlorinated water, the conditions including flowrate of the pre-chlorinated water, pH of the pre-chlorinated water, and pressure of the pre-chlorinated water.

7. The method of claim 1, further comprising ceasing the lowering of the pH of the pre-chlorinated water when the pH of the pre-chlorinated water falls below a threshold or when the pressure of the pre-chlorinated water rises above a threshold, or when the pre-chlorinated water flowrate drops below a threshold flowrate.

8. The method of claim 5, further comprising intermittently lowering the pH of the pre-chlorinated water based on time.

9. The method of claim 5, further comprising intermittently lowering the pH of the pre-chlorinated based on pre-chlorinated water volume.

10. The method of claim 1, wherein the lowering of the pH of the pre-chlorinated water includes adding from 2.0 to 4.0 mL of acid for every gallon of pre-chlorinated water.

11. A system for preventing scale formation in a water sanitizes comprising:
a pre-chlorinated water line and a pH sensor attached to the pre-chlorinated water line;
an acid storage container connected to an acid feeder, the acid feeder connected to the pre-chlorinated water line via an acid injection port;
a scale prevention system controller functionally connected to the pH sensor and the acid feeder, wherein the scale prevention system controller lowers the pH of the pre-chlorinated water line using the acid feeder with an amount of acid sufficient to inhibit scale formation.

12. The system of claim 11, further comprising a mixer in the pre-chlorinated water line downstream from the acid injection port.

13. The system of claim 12, wherein the pH sensor is located downstream of the acid injection port and the mixer.

14. The system of claim 11, further comprising a fail-closed control valve located between the acid storage container and the acid feeder, and functionally connected to the scale prevention system controller.

15. The system of claim 11, further comprising a chlorinator connected to the pre-chlorinated water line, the chlorinator including a chlorine solids hopper, a support grid, and a chlorinated water output line,
wherein a second pH sensor is located on the chlorinator or the chlorinated water output line, and the second pH sensor is functionally connected to the scale prevention system controller.

16. The system of claim 11, further comprising a check-valve connected between the acid feeder and the acid storage container, preventing backflow into the acid storage container.

17. The system of claim 11, wherein the acid feeder is a positive displacement pump such as a peristaltic pump, reciprocating pump, or rotary lobe pump.

18. The system of claim 11, wherein the acid feeder is a gravity feeder, vacuum feeder, or siphon feeder having an acid flow measurement sensor and control valve that are functionally connected to the controller.

19. The system of claim 11, wherein the scale prevention system controller determines whether one or more conditions are met prior to the lowering the pH of the pre-chlorinated water, the conditions including flowrate of pre-chlorinated water, pH of the pre-chlorinated water, and pressure of the pre-chlorinated water; and
wherein the scale prevention system controller stops acidification when one or more conditions are met, the conditions including flowrate of pre-chlorinated water, pH of acidified pre-chlorinated water, and pressure of the pre-chlorinated water.

20. The method of claim 11, wherein the scale prevention system controller provides a constant trickle of acid to the pre-chlorinated water line, or wherein the scale prevention system controller provides bursts of acid intermittently to the pre-chlorinated water line.
